(19) United States
(12) Patent Application Publication
(10) Pub. No.: US 2012/0086632 A1
(43) Pub. Date: Apr. 12, 2012

(54) ELECTRIC POWER INFORMATION USER INTERFACE, DISPLAY METHOD AND APPARATUS THEREOF

(75) Inventor: TSUNG-CHIH LIN, TAIPEI HSIEN (TW)

(73) Assignee: POWERTECH INDUSTRIAL CO., LTD., TAIPEI HSIEN (TW)

(21) Appl. No.: 12/948,944

(22) Filed: Nov. 18, 2010

(30) Foreign Application Priority Data
Oct. 11, 2010 (TW) 99134637

(51) Int. Cl. G09G 5/00

(52) U.S. Cl. 345/156

(57) ABSTRACT

Disclosed herein relates to an electric power information user interface, an information display method and an apparatus thereof. The interface is used to display the electricity consumption to be detected. The apparatus may display diverse power information through several functional combo keys. The interface is particularly implemented by software. The interface includes a value-display area, a parameter-type area with several changeable symbols or texts, a parameter-unit area indicative of unit of the value, a statistics-mode area for providing inquiry into the electric power information at different period zones, and a functional-key area. The functional-key area has several multi-functional keys and an energy-count key that is used to generate a reset and a stop command by repeating triggering. The energy-count key particularly provides the electric power information within a certain period.

### BACKGROUND OF THE INVENTION

1. Field of the Invention

The instant disclosure relates to a power information user interface, method and a related apparatus, in particular, to provide a human interface for displaying electricity statistics.

2. Description of Related Art

The conventional electricity meter merely shows the electricity consumption, but not any customized configuration made through a user interface. The user may not configure a computing mode, related parameters or any display method as he requires.

Also, the accumulative electricity consumption displayed on the conventional electricity meter is not the real-time information. It is not an easy work for the user to acquire the electricity consumption, power rate, or even the emission of carbon-dioxide within a specific period of time.

### SUMMARY OF THE INVENTION

Disclosed in the disclosure are power information user interface, display method and the related apparatus. The power display apparatus includes a computing circuit for computing the electricity consumption of any specific appliance, via any receptacle socket or a whole power loop. The apparatus further provides a user interface for the user configuring the computing mode or parameters. Base on the configuration of computing mode or parameters, the instant power information can be shown with changeable symbols, texts or lights.

In one of the embodiments, each display area of the power information user interface shows the related information associated with the electricity. The areas include a value-display area representing the value with number or histogram. The areas further have a parameter-type area describing the meaning of the value shown in the value-display area. The areas also have one or more parameter-unit areas that designate the unit of the value in the value-display area by several changeable symbols or texts. The areas include a statistics-mode area having a plurality of period-display areas, which provide the selections of the configurable period zones for inquiring the diverse power information. The parameter-unit area may include a first parameter-unit area indicative of the units of currencies, and a second parameter-unit area showing the units of values.

In particular, a functional-key area is included. The functional-key area includes a plurality of keys, which may be implemented as tangible buttons, or the software-implemented keys for triggering the functions. The keys allow the user to instantly acquire the required information, rather than the hierarchical selections.

Furthermore, the display panel particularly includes a surge-warning area. The apparatus has a circuit for measuring an instantaneous large current or a very high surging within a short time. The surge-warning area may generate a warning signal while detecting the surge.

The functional-key area further has an energy-count key for fast executing the reset or stop command as triggering a reset or stop process. Further, the process may reset or stop the statistics counting by repeatedly pressing or touching the energy-count key. Moreover, the energy-count key allows the user to configure a statistic period for acquiring the power information within a certain period zone.

The power information related display apparatus mainly includes a control unit which is used to integrate the signals among the circuits. An electricity-detection unit, a computation unit and a display unit used for displaying the described interface and the power information are also included in the apparatus. The apparatus further has an input unit having the tangible keypad. An energy-count key and some reconfigurable functional combo keys are particularly disposed. The combo keys exemplarily include an energy key, a cost key, and a carbon-dioxide emission key.

The energy-count key is used to configure a start time and a stop time for generating statistics of electricity consumption within a period of time.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the display areas of the power information user interface;

FIG. 2 is a schematic diagram of the user interface in one embodiment of the invention;

FIG. 3A to FIG. 3F schematically show the continuous operations of displaying the power information of the power display apparatus;

FIG. 4 shows a schematic diagram of the power display apparatus coupled with a plug in accordance with first embodiment;

FIG. 5 shows a schematic diagram of the power display apparatus coupled to an electric socket in accordance with second embodiment;

FIG. 6 shows a schematic diagram of the power display apparatus embedded in an outlet in accordance with third embodiment;

FIG. 7 depicts a circuit block of the power display apparatus in accordance with the invention;

FIG. 8 illustrates a flow chart of using the functional key showing the electric statistics of the invention;

FIG. 9 illustrates a flow chart of using the energy-count key in one of the embodiments of the invention.

### DETAILED DESCRIPTION OF THE PREFERRED EMBODIMENTS

A power information user interface is particularly presented in the instant disclosure. A display method and the related apparatus with the configurable user interface are also disclosed. Some functional detection circuits for measuring the voltage and current over the apparatus are disclosed. For example, the related power information is displayed on the panel after the circuit or IC implemented computation unit quantifies the voltage or current signals.

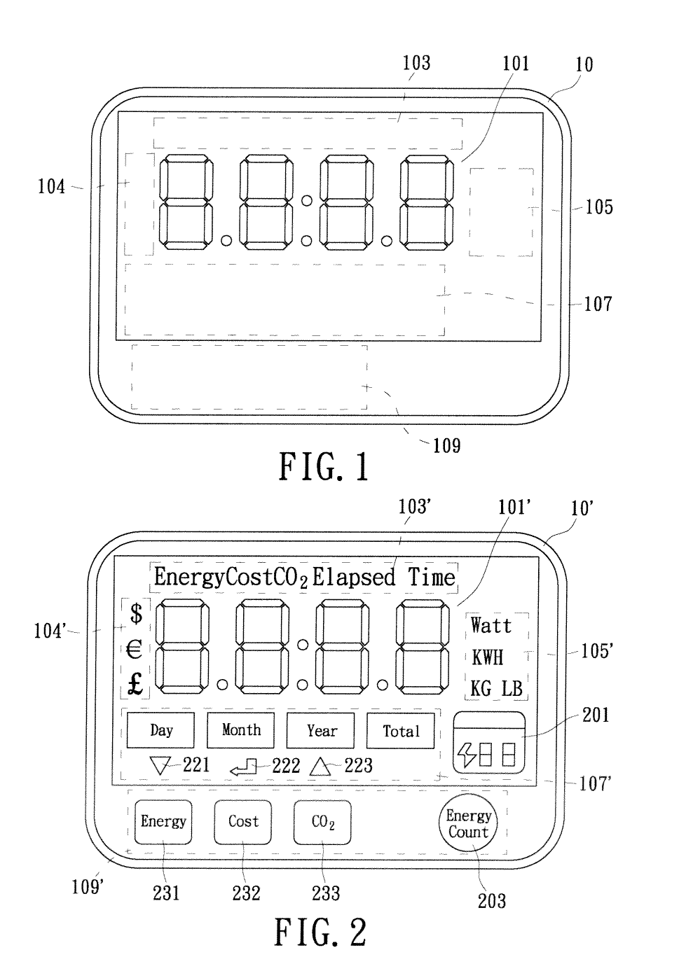

FIG. 1 shows a schematic diagram of the various display areas of the power information user interface.

The detection circuit generates the power information by detecting the electricity. As acquiring statistics of the electricity consumption, the user interface is used to display the diverse power information. The interface of the power display apparatus 10 is configured to display the power information through the panel. In particular, the user interface is implemented by means of software. Through the software-implemented interface, the statistics of the count with respect to the diverse power information may be variously presented based on the measurements made by the internal circuits. According to one embodiment, the software-implemented interactive interface provides a plurality of display areas in which power information is displayed. The functional combo keys are functioned to display the various statistics of the measurements.

Each display area shows the content in compliance with its own function. For example, a value-display area 101 is introduced to displaying the statistics with numbers. In one further embodiment, the statistics of electricity consumption is described by the waveforms or curves. A parameter-type area 103 is used to show the meanings of the values in the value-display area 101. In particular, the parameter-type area 103 uses several reconfigurable symbols or texts to designate the meanings of values displayed in the value-display area.

Furthermore, the interface includes a parameter-unit area with one or more icons. Those icons may be expressed by some reconfigurable symbols or texts for designating the units of the values in the value-display area 101. In an example, the parameter-unit area has the shown first parameter-unit area 104, in which many signs of units are included. According to the mode of the statistics, a unit in accordance with a specific value in the value-display area 101 is displayed. The parameter-unit area 104 further has a second parameter-unit area 105, which also includes various units fit it with the values.

The display area further includes a statistics-mode area 107, which has several period-display areas. Each period-display area represents one of the configurable periods including daily, monthly, yearly and a summation. The period-display areas allow the user to inquire the statistics of electricity consumption within any configurable period.

The functional-key area 109 includes a plurality of keys which may be the switchable keys implemented by software or the tangible buttons. Each key may conduct a fast instruction that allows the user to reach the required information without any extra selection.

FIG. 2 shows the schematic diagram of the user interface for displaying the power information.

A power display apparatus 10′ is shown. A display panel thereon is used to display the diverse power information. The apparatus 10 uses a detection circuit (not shown) to measure the electricity consumption, and a computation circuit then converts the information into values.

According to the current embodiment, referring to the display areas described in FIG. 1, the value-display area 101′ uses numbers to show the statistics of the count. The parameter-type area 103′ designates the meanings of the values shown in the value-display area 101′. Furthermore, the parameter-type area 103′ provides the various indicators due to the configuration. The indicators serve as the indications of statistics of energy, cost, emission of carbon-dioxide, and the elapsed time.

Since the value-display area 101′ may express the various statistics, the first parameter-unit area 104′ and the second parameter-unit area 105′ are configured to conduct the changes. For example, the first parameter-unit area 104′ is capable of designating the various units of currencies such as U.S. dollars ($), Euro ( [symbol] ) and pound (£). To accord with the rate in the different countries, a proper unit of currency can be displayed. For example, the units listed in the second parameter-unit area 105′ may include Watt, KWH, KG, LB that designates the units of the measure associated with the value-display area 101′.

A statistics-mode area 107′ shows the value in response to the statistics within different period. According to one of the embodiments, the value-display area 101′ is reconfigurable for various statistics since several functional combo keys are configurable among “Day” key for daily statistics, “Month” key for monthly statistics, and “Year” key for yearly statistics, for example. Those values are used to show the specific electricity consumption within a predefined period. The embodiments of the disclosure are not limited to above-mentioned period zones.

In one embodiment, several tangible keys are used in this functional-key area 109′. Each key is configured to execute a shortcut command. The user may trigger a key and an instant result is correspondingly displayed in the value-display area 101′. The functional-key area 109′ at least has a first functional combo key 231, such as an energy key, for displaying the electricity consumption. The area 109′ also has a second functional combo key 232, such as a cost key, for displaying the cost in a period. Further, a third functional combo key 233 is included in the area 109′ for displaying the carbon-dioxide emission since it is designated as a CO₂ key.

A surge-warning area 201 is particularly introduced and disposed on the display panel in one further embodiment. This surge-warning area 201 is triggered to perform a process that detects the large current or high voltage in a very short time from the instant power information, and therefore the information brings an alarm.

The functional-key area 109′ particularly has an energy-count key 203 for counting the energy within a configurable period. Preferably, the energy-count key 203 may be a clickable or touchable parameter key in accordance with the instant application. The repeated clicks or touches may perform a reset or a stop command alternately; therefore, the statistics within a period may be reset or stopped. The energy-count key 203 is to process a count such as the process made by a real-time counter. By alternately triggering the energy-count key 203, a period zone can be set. Then power information within the period zone can be displayed.

For example, if the energy-count key 203 is firstly triggered, a reset command is launched to perform a reset process for the previous statistics. If the energy-count key 203 is secondly triggered, a stop command is performed to conclude the statistics since the counting process stops. The power information is thereby displayed according to the generation of statistics in any period zone.

The power information in the power display apparatus 10′ may provide many types of statistics for reference. For example, an overall statistics of electricity consumption from initial is provided, and generally not allowed to be reset. One more temporal statistics for a certain period is provided and able to be reset. The above mentioned energy-count key 203 is used to sum up the electricity consumption for a period of time.

For example, since the first functional combo key 231 for energy statistics is triggered, the value-display area 101′ displays the power quantity. The related unit is preferably displayed as the “Watt” in the second parameter-unit area 105′. The parameter-type area 103′ prompts that as “Energy”. The first functional combo key 231 is provided for the user triggering it repeatedly for selecting the statistics of energy in several switchable periods in the statistics-mode area 107′. For example, if the user clicks the first functional combo key 231 twice or for a while, the value-display area 101′ can display the daily power consumption. If the user clicks the key three consecutive times or for another time, the value-display area 101′ displays the monthly statistics of the count.

Furthermore, if the user triggers the second functional combo key 232 for acquisition of cost information, the value-display area 101′ displays the fee for a selected period. The user may use the related unit based on his configuration. For example, the U.S. dollar sign “$” can be shown.

If the user triggers the third functional combo key 233 for estimating the carbon-dioxide emission, the value-display area 101′ displays the estimation of the emission of carbon-dioxide. The related unit can be KG or LB displayed in the second parameter-unit area 105′.

The power display apparatus 10′ for displaying the power information may include further user-defined functions, including the time setting, date setting, nationality setting, the predefined functional combo keys, and even the fee schedule of electricity consumption, and setting of grace period. Any combination of the functional combo keys may also provide the various user interfaces for configurations. The functional combo keys provides the combo configurations, for example, the plurality of shared keys are used to switch the shared-key function-switched indicator 221, 222, and 223 for prompting the instant functions.

Further, the described shared-key function-switched indicator 221, 222, 223 may include some reconfigurable symbols or texts such as up sign and down sign for providing many options for user's operations.

While entering a configuration page, for example, the interface of configuration for unit of currency, the first functional combo key 231 corresponding to the icon 221 with up and down signs can be configured to make a selection. Meanwhile, the configurable symbols or texts in first parameter-unit area 104′ may then blink. The blinking icons may be switched depending on the user's operation. After that, the second functional combo key 232 corresponding to the indicator 222 performs a storing process of the configurations.

Some other processes may include the configurations of fee schedule, units, and the computation of carbon-dioxide emission. These configurations may be performed by the user's operations on the first, second, and third functional combo keys 231, 232 and 233. The operations, such as repeating the clicks, holding the pressed key, and the combination of the shared key, are associated with the shared-key function-switched indicators 221, 222 and 223. Therefore, the interactive interface may provide the combo-key functions since the field of interface and the key arrangement is limited.

It is worth noting that the interface of power display apparatus of the instant disclosure has a surge-warning area 201. When the detection circuit detects a large current or voltage occurring in a very short time, the apparatus generates a surge alarm. For example, the alarm may be implemented as lighting, blinking, or sound. On the instant, the power display apparatus may interrupt the power in order to protect other appliances.

The power display apparatus further provides the surge counting. In addition to alarming by lighting or sound as detecting the surge, the display area also shows the number of times thereof. In which, the user may define the range of surge by himself. For example, using the functional combo keys, the range of a minor surge is set as surpassing 250V to 330V. A major surge is defined as larger than 330V since the surge may damage the appliances. The surge exceeding 330V can be regarded as the major surge and trigger an interrupt signal to power off the apparatus.

The energy-count key 203 is particularly incorporated into the apparatus for acquiring the electricity consumption of a specific appliance or the electric rates in a certain period. On the other words, the energy-count key 203 allows the user to acquire the electricity consumption within a specific time interval. For example, the energy-count key 203 may help people acquire the electricity consumption over a whole night, the consumption as turning on the air conditioner or other appliances which consume large power.

However, the energy-count key 203 also allows the user to reset the previous record of electricity. For example, when the user triggers the energy-count key 203 at first time, the process starts to conduct the statistics of the power consumption. The process of statistics then stops as the user triggers the energy-count key 203 again. After stopping the statistics process, the value-display area shows the power information within the period between the first and the second triggering events. Those functional combo keys also help people checking the information of power consumption, fee and the emission of carbon dioxide.

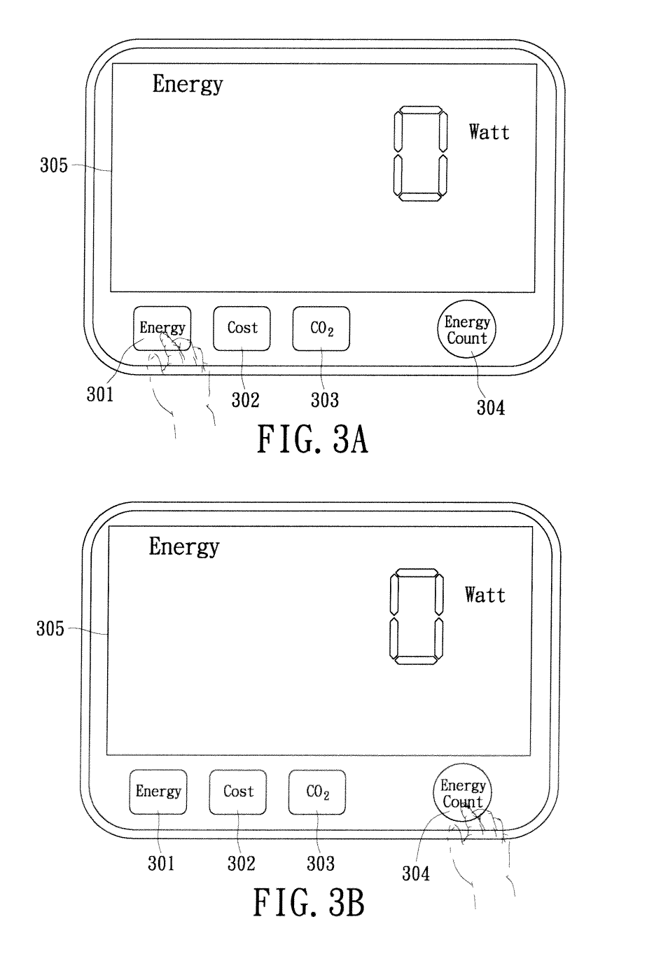

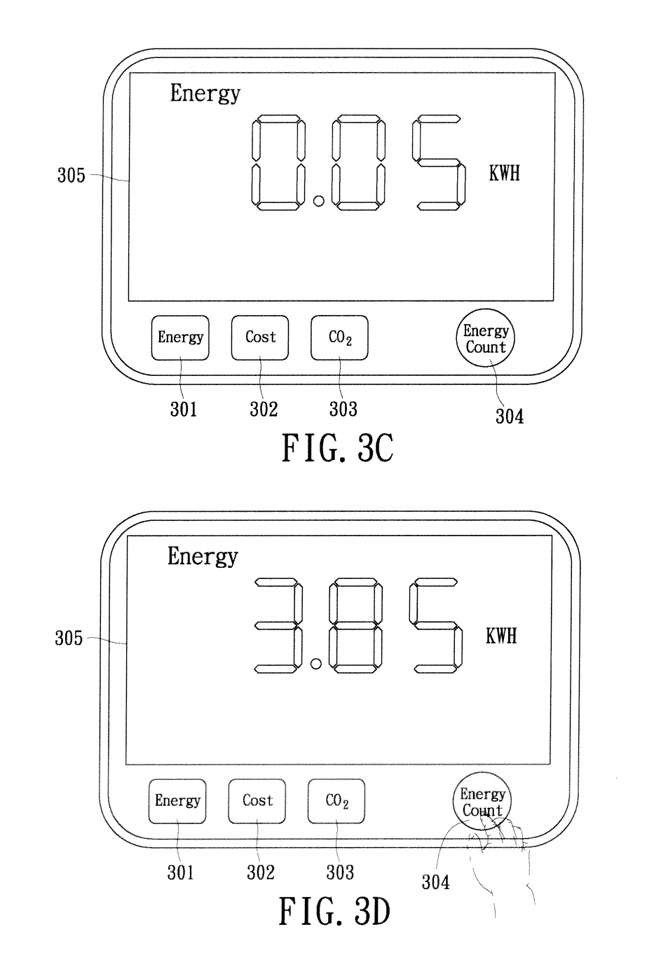

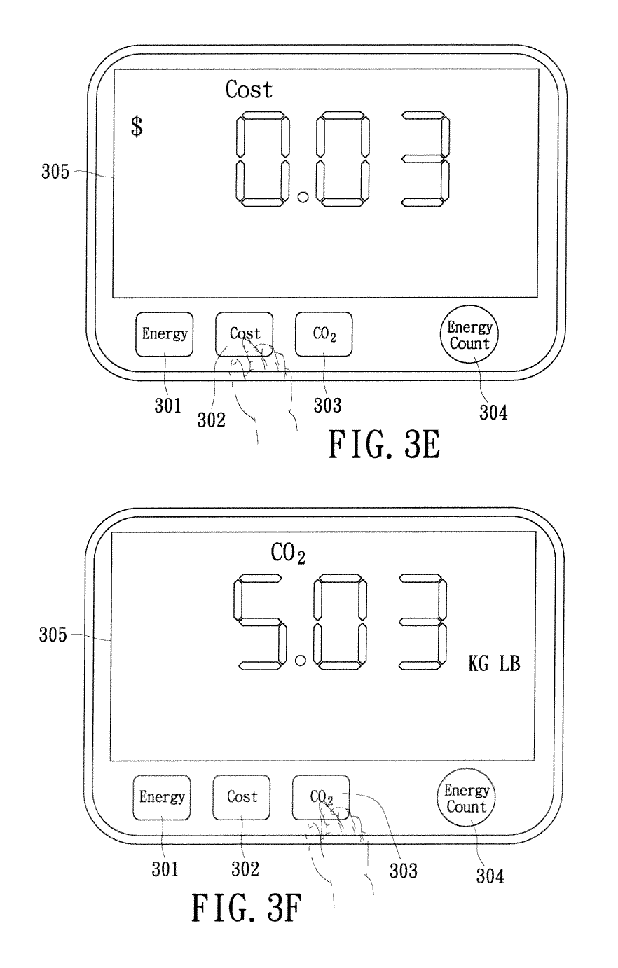

References are made to FIG. 3A to FIG. 3F illustrating the operations of the energy-count key.

FIG. 3A shows a schematic diagram of the power display apparatus. An energy-count key 304 is disclosed. Firstly, the user triggers the first functional combo key 301 and a value-display area 305 accordingly displays “Energy” for designating the power quantity by statistics, and its unit may be Watt.

Next, as shown in FIG. 3B, the user may trigger the energy-count key 304 to reset the value of the recorded statistics. After that, the process may further proceed to generate statistics of power consumption. FIG. 3C shows the related unit is switched to “KWH”. After proceeding the statistics for a period of time, the user may trigger the energy-count key 304, such as shown in FIG. 3D, to execute a stop command of statistics generation. The value-display area 305 then displays the result of statistics in this period.

Further in this example, the user may trigger the second functional combo key 302, such as FIG. 3E, to display the related fee within the period onto the value-display area 305. Meantime, the parameter mode is switched to “Cost”, and a U.S. dollar sign is shown on the first parameter-unit area.

Still further, if the user triggers the third functional combo key 303, such as FIG. 3F, the parameter mode is switched to “CO₂” and the estimation associated with the emission of carbon dioxide is displayed on the value-display area 305 with a proper unit of “KG”.

The above exemplary example may properly change as required.

The power display apparatus of the instant disclosure is exemplarily connected to an indoor distribution box. Therefore, the apparatus may serve to display the power information associated to the whole electric circuit. In one further example, the power display apparatus may electrically connect to a power extension outlet having a plurality of receptacles, or a standalone receptacle for acquiring the power information there-through. The apparatus may serve to acquire the power consumption of all the appliances connected to the outlet or of single appliance. Furthermore, the apparatus may wirelessly link with the power extension outlet or standalone receptacle.

### First Embodiment

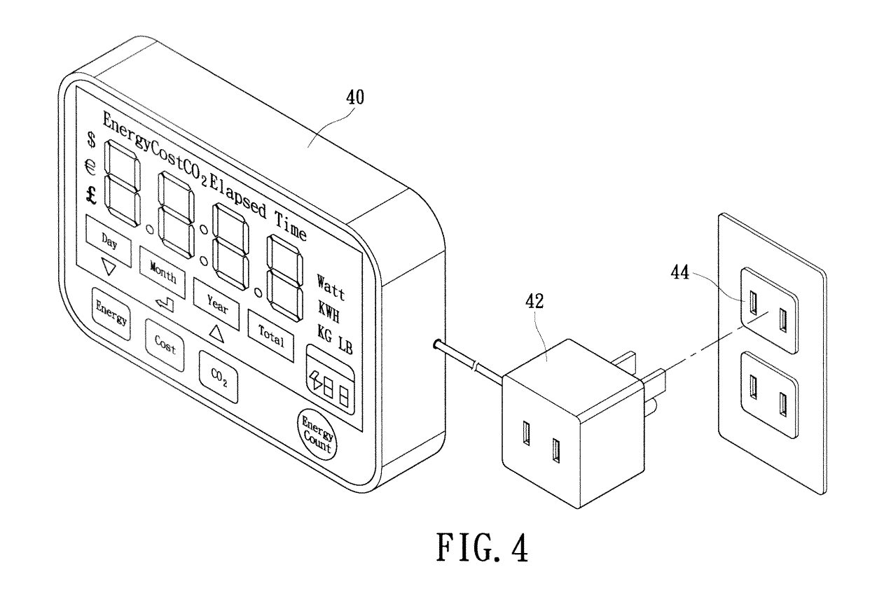

Reference is made to FIG. 4. A power information display apparatus 40 is disclosed. The apparatus 40 is wired to a receptacle adapter 42. Since the power display apparatus 40 has an electricity measure circuit bridged over contacts (not shown) of the receptacle adapter 42. Therefore, a standalone device is assembled.

The electricity consumption of any appliance connected to the socket 44 of this adapter 42 can be measured over the detection circuit of the power display apparatus 40. Through recording and statistics generation, the related power information there-through can be displayed on the panel of the power display apparatus 40.

### Second Embodiment

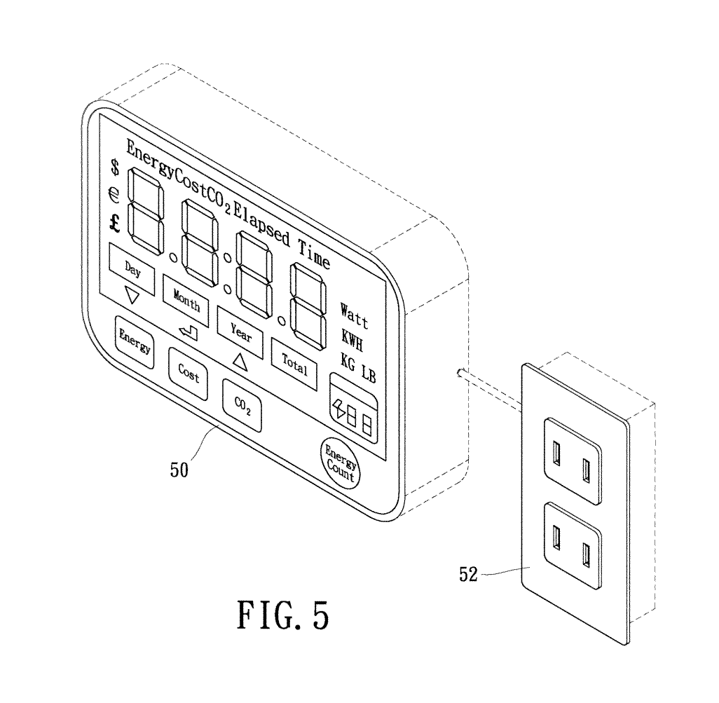

One further embodiment is shown in FIG. 5, where a wall-type receptacle 52 buried onto the wall or any fixture is disclosed. The disclosed power display apparatus 50 is disposed on a side of the receptacle 52. The apparatus 50 utilizes a detection circuit bridged over the contacts inside the receptacle 52 to detect the consumed electricity passing through the receptacle 52. The relevant power information can be displayed on the panel of the power display apparatus 50.

### Third Embodiment

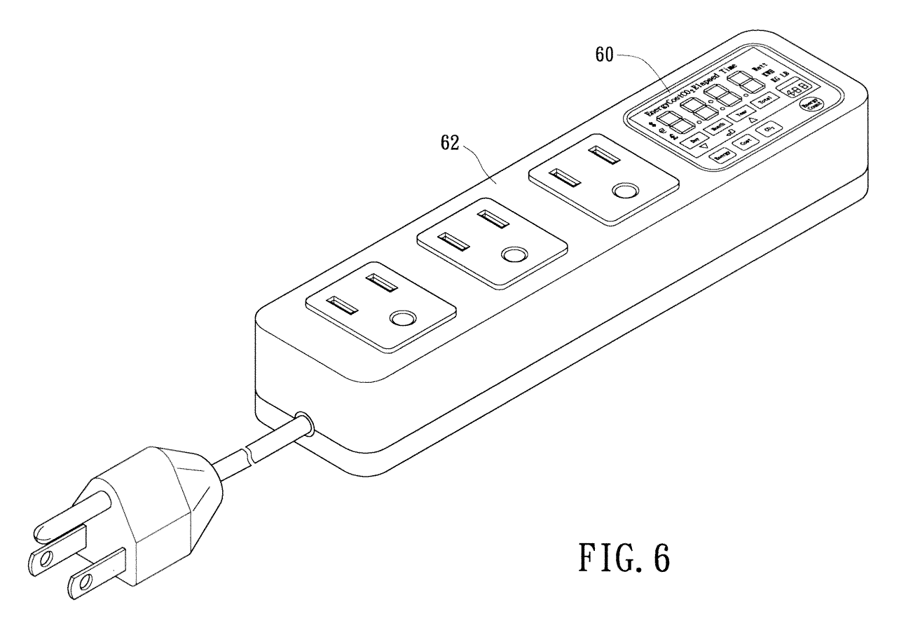

FIG. 6 schematically shows a power display apparatus 60 disposed onto a power extension outlet 62. The power extension outlet 62 includes several sockets for supplying power to the many appliances. The power display apparatus 60 can therefore utilize the detection circuit connecting over the contacts of the outlet 62 to detect the electricity consumption of the appliance. The apparatus 60 can acquire the power information through the power extension outlet 62. Similarly, the power information can be displayed on the user interface of the apparatus 60.

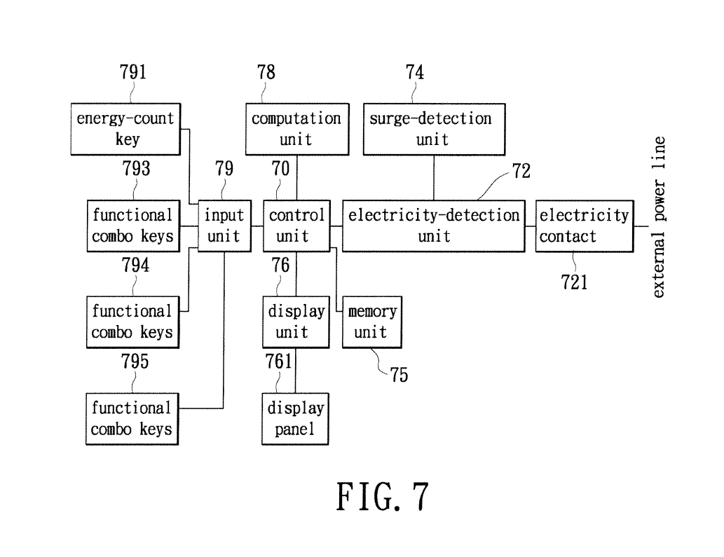

The inner circuits of the power display apparatus are presented as the functional blocks shown in FIG. 7.

The power display apparatus embodies the circuits or an integrated circuit for electricity detection, statistics generation and displaying of the power. The relevant functional blocks for each element or circuit layout of the apparatus are shown.

A control unit 70 is a major component which integrates the signals among the circuits. The power display apparatus substantially includes an electricity-detection unit 72, which is electrically connected to the control unit 70. The detection unit detects the current or voltage passing through the apparatus. The corresponding signals are generated and transmitted to the control unit 70. Preferably, the electricity-detection unit 72 uses a set of electric contacts 721 to connect an external power line for acquiring the electric signals.

The electric signals, such as the current and voltage, are quantized by a computation unit 78. Since the computation unit 78 connects to the control unit 70, the control unit 70 may acquire kinds of electric data there-from. The computation unit 78 can acquire the quantized data based on some formulas, such as the power quantity shown as Watt, the electricity consumption as degree, fee or the estimation of emission of carbon dioxide emission.

Furthermore, the apparatus may have a surge detector like the surge-detection unit 74 connected to the electricity-detection unit 72. Thereby, the apparatus may find out the abnormal voltage or current signals from the electricity-detection unit 72. If the surge-detection unit 74 confirms the unusual signals, the apparatus then conducts counting and announces an alarm. The kinds of power information may be displayed on the display panel 761 of display unit 76 via the control unit 70. The related data is recorded into the memory unit 75. The memory unit 75 is electrically connected to the control unit 70 substantially for storing or recording the signals to be detected. Those data allows the users to inquire the power information displayed on the panel. The memory unit 75 further stores the executable instructions of the interactive interface. The interactive interface is shown on the display panel 761 as initiating the apparatus via the instructions.

An input unit 79 connected with the control unit 70 is shown in the figure. The input unit 79 has several tangible keys disposed on the panel. The keys are an energy-count key 791 and several reconfigurable functional combo keys 793,794,795. The tangible keys allows the user to view the instant information such as the energy information with the energy key, the cost with the cost key, and the estimation of emission of carbon dioxide. The user may use the energy-count key 791 to configure a start time and a stop time to generate the power statistics.

Through the functions made by the display panel 761 and the functional combo keys 793, 794, 795, the user may input the information of grace period and fee schedule to the power display apparatus. It is featured that the fee indication can be seen on the interactive interface.

When the user triggers the energy-count key, a first electricity-counting signal is generated for conducting a reset process. The first electricity-counting signal resets the previous statistics and starts from an initial state. The process of generating statistics may not stop until the user triggers again for generating a second electricity-counting signal. This second electricity-counting signal is a stop command for the process of power statistics.

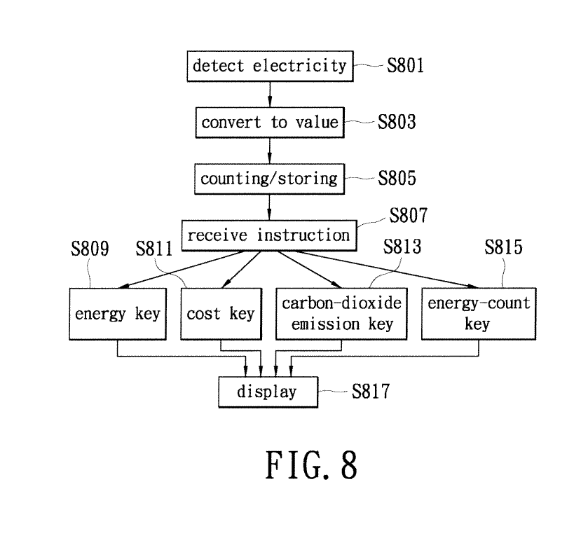

According to the process depicted in FIG. 8, the power display apparatus utilizes an electricity measure circuit to measure the electricity consumption of a specific object (step S801). The measurement is then converted into the power information shown by values (step S803). The power information associated with the statistics is recorded (step S805).

The above described steps are continuously operating from the initial stage. Instructions generated in response to triggering key made by the user are received during the procedure (step S807). Under a default condition, the display panel may display the general information regarding the electricity consumption, for example, the daily life information such as time and date.

The user may inquire the statistics for the various periods via the interactive interface. The statistics includes electricity consumption, fee indication and emission of carbon dioxide.

In step S807, the apparatus generates the instructions in response to the functional combo key or energy-count key the user triggers. Then the related power information is displayed in step S817. Each process in response to every triggering event, such as triggering the energy key, includes a series of instructions for performing shortcut steps (step S809). A corresponding content with respect to the power information is displayed. For example, if a triggering event is launched as triggering the cost key (step S811), a series of instructions are processed to display a fee indication. If the trigger event launches as triggering the carbon-dioxide emission key (step S813), the corresponding instructions are processed to display the related content. Further step in the method is to trigger the energy-count key, and to display the statistics of the count (step S815).

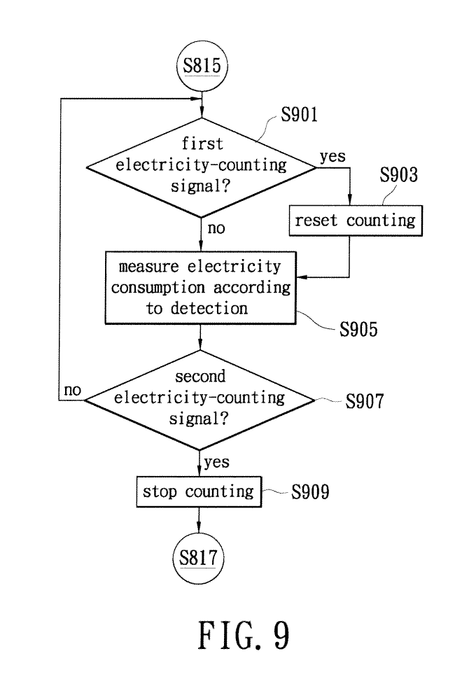

The procedure of triggering the energy-count key may be referred to the flow described in FIG. 9.

In step S815, the user triggers the energy-count key. The control unit of the apparatus generates a series of instructions in response to the triggering (step S815). The step next is to determine if the [symbol] first electricity-counting signal is generated (step S901). In an example, this energy-count key may be a parameter switch able to provide multiple functions, so that the corresponding instruction may be generated based on the number of times of switching, or holding the button for a while. The first and second electricity-counting signals are alternately generated by repeatedly triggering the energy-count key. For example, a first triggering of the energy-count key generates the first electricity-counting signal. Since the first electricity-counting signal has been generated, the next triggering of the key may generate the second electricity-counting signal.

After the determination, such as step S903, a reset command is processed to reset the statistics of the apparatus since the first electricity-counting signal has been generated at that moment. The statistics value is able to provide the counting of energy rather than the electricity of the whole apparatus. The generation of the first electricity-counting signal allows the computation unit of the apparatus to reset the value by referring to the electricity statistics (step S905).

Otherwise, if the first electricity-counting signal does not exist, it shows the statistics is in progress. Such as step S905, the computation unit is to measure the electricity consumption based on the detection of power quantity. The step in the method continuously detects if the second electricity-counting signal is generated (step S907). This second electricity-counting signal is generated by second triggering of the energy-count key. The second triggering event conducts a stop command for stopping the current statistics. If the second electricity-counting signal is generated, it shows the step goes to stop the process of statistics (step S909). The step may next go to the step S817 of FIG. 8, in which the electricity statistics or the related information intervening between the reset and the stop command is displayed on the display panel of the apparatus.

At this moment, if no any second electricity-counting signal is generated, it means that the user does not stop the current statistics and repeat the step S905. The process of the statistics of the electricity may not stop until the stop signal is generated.

It is noted that the above embodiments may not limit the scope of invention.

To sum up the above description, the power information user interface, display method and the related apparatus provides an easy and convenient user interface for displaying the power information via an interactive interface. Therefore, the diverse power information may be instantly shown up.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A power information user interface, comprising:
a power-information generating means, generating information of electricity through detection of electricity consumption;
a functional-key area, comprising a plurality of keys, the instructions are executed by triggering one of the keys;
a display panel, displaying a plurality of display areas by software means, wherein the display areas comprise:
a value-display area, displaying the information of electricity;
a parameter-type area, having a plurality of reconfigurable symbols or texts, designating the meanings of values displayed in the value-display area;
a parameter-unit area, having a plurality of reconfigurable symbols or texts, designating one or more units of the values displayed in the value-display area; and
a statistics-mode area, having a plurality of period-display areas, for inquiring information of electricity within different period zones.

2. The user interface of claim 1, wherein the parameter-type area shows the meanings of indications of power consumption, fee, carbon-dioxide emission, and statistic period.

3. The user interface of claim 1, wherein parameter-unit area includes a first parameter-unit area, which is used to display unit of currency for the values in the value-display area.

4. The user interface of claim 3, wherein the parameter-unit area further includes a second parameter-unit area, which is used to display unit of measure of the value of the value-display area.

5. The user interface of claim 1, wherein each period-display area of the statistics-mode area is used to display value of several switchable periods including daily, monthly, yearly statistics and a summation.

6. The user interface of claim 1, wherein the user interface further comprises a surge-warning area, which is used to generate an alarm as resulting in a large current or high voltage within a short time.

7. The user interface of claim 1, wherein functional-key area includes a plurality of tangible keys having:
an energy key configured to show power quantity;
a cost key configured to show fee related to the power quantity, and
a key configured to show estimation of emission of carbon dioxide.

8. The user interface of claim 7, wherein the functional-key area further comprises an energy-count key, which is used to perform a reset or a stop command, and a corresponding reset process or stop process is performed by repeatedly triggering the energy-count key.

9. The user interface of claim 7, wherein the user interface comprises a plurality of shared-key function-switched indicators for prompting the current function conducted by the functional combo keys.

10. A power display apparatus with the power information user interface as recited in claim 1, comprising:
a control unit;
an electricity-detection unit, electrically connected to the control unit, for detecting electric signals over the power display apparatus;
a computation unit, electrically connected to the control unit, for quantifying the power information from the control unit;
a display unit, electrically connected to the control unit, for displaying the power information from the control unit using the user interface;
an input unit, electrically connected to the control unit, having several keys on a panel, wherein the keys are an energy-count key and a plurality of reconfigurable combo keys, and the combo keys includes:
an energy key, configured to display power quantity as executing a series of instructions by triggering the energy key;
a cost key, configured to display fee as executing a series of instructions by triggering the cost key;
a carbon-dioxide emission key, configured to display emission of Carbon Dioxide as executing a series of instructions by triggering the carbon-dioxide emission key;
wherein, the energy-count key is triggered to configure a start time for counting electricity and a stop time for acquiring the power information from the start time through the stop time.

11. The apparatus of claim 10, wherein the electricity-detection unit connects an external power line via a set of electricity contacts.

12. The apparatus of claim 10, further comprising a surge-detection unit electrically connected to the control unit.

13. A power information display method, adapted to a power display apparatus, comprising:
the power display apparatus using an electricity measure circuit to measure power quantity;
converting the power quantity into various power information;
generating statistics for the various information; and
in response to an instruction, displaying one type of the power information;
wherein, if the instruction with respect to a first electricity-counting signal is generated by triggering an energy-count key, it's to reset the statistics and start to count; if the instruction is a second electricity-counting signal, it's to stop the statistics, and the statistics of the count is displayed.

14. The method of claim 13, wherein, when the instruction is generated, the instruction is the second electricity-counting signal if the first electricity-counting signal has been generated.

15. The method of claim 14, wherein the first electricity-counting signal and the second electricity-counting signal are alternately generated by repeatedly triggering the energy-count key.

16. The method of claim 13, wherein the instruction is:
instruction in response to triggering an energy key;
instruction in response to triggering a cost key; and
instruction in response to triggering a carbon-dioxide emission key.

17. A power information user interface, comprising:
a detection circuit, for detecting electricity consumption;
an energy-count key, for generating power information within a period zone set by alternately triggering the energy-count key;
a display panel, for displaying a plurality of display areas by means of software; wherein, the display areas comprises:
a value-display area, for displaying the power information;
a parameter-type area, having a plurality of reconfigurable symbols or texts for showing the meanings of values displayed in the value-display area;
a parameter-unit area, having a plurality of reconfigurable symbols or texts for indicating the units of the values in the value-display area; and
a statistics-mode area, for displaying the period zone.

18. The user interface of claim 17, wherein the user interface is electrically connected to a power extension outlet or a standalone receptacle.

19. The user interface of claim 17, wherein the user interface is wirelessly connected to a power extension outlet or a standalone receptacle.
